(19) United States
(12) Patent Application Publication
(10) Pub. No.: US 2020/0018337 A1
(43) Pub. Date: Jan. 16, 2020

(54) FASTENING SYSTEM FOR CONNECTING TWO FRAME ELEMENTS OF A BED FRAME AND BED FRAME

(71) Applicant: LOGICDATA Electronic & Software Entwicklungs GmbH, Deutschlandsberg (AT)

(72) Inventors: Haymo NIEDERKOFLER, Graz (AT); Robert SACKL, Frauental (AT)

(21) Appl. No.: 16/034,253

(22) Filed: Jul. 12, 2018

(51) Int. Cl. F16B 12/54; A47C 19/04; A47C 19/00; F16B 12/10; F16B 11/00

(52) U.S. Cl. CPC F16B 12/54; A47C 19/04; F16B 2012/106; F16B 12/10; F16B 11/006; A47C 19/005

(57) ABSTRACT

The invention relates to a fastening system for connecting two frame elements of a bed frame, in particular for an adjustable bed, wherein the two frame elements each comprise a hollow profile, the fastening system comprising: a mounting element, which is firmly attachable to an end of the first frame element, and a connector part, which is insertable into the hollow profile at an end of the second frame element and firmly connectable to second frame element, wherein the mounting element comprises at least one mounting hole, the connector part comprises at least one mounting spigot corresponding to the at least one mounting hole, which is designed to be plugged into the at least one mounting hole, the connector part comprises at least one mounting mechanism for a detachable, firm connection of the mounting element and the connector part.

The invention relates to a fastening system for connecting two frame elements of a bed frame, in particular for an adjustable bed. Furthermore, the invention relates to a bed frame comprising such a fastening system.

Adjustable beds, for example comfort beds or care beds, are widely known. These beds typically comprise a bed frame. Beds of an adjustable type typically comprise a head part, a center part and a foot part, the head part and/or the foot part being adjustable in order to change a reclining position. Further, horizontal displacement of the head, center and/or foot part is typically possible. Typically, this is effected by means of one or multiple actuators driving a respective mechanism for adjusting the head part, center part and/or foot part. Due to various provisions and/or customer wants, there is a large variety of adjustable beds. On the one hand, this relates to the adjustability of the bed per se, wherein it may be desired to only adjust the head part, the foot part or both parts, for example. On the other hand, this relates to the different sizes of the bed such as king-size, queen-size, twin-size or the like. As a result, there is a huge variety of adjustable beds that come with a variety of frames and necessary drive technologies. Further, an adjustable bed represents a financial investment and therefore a bed is typically taken along during a change of residence. In America and generally in the English-speaking area, changes of residence are quite common.

One object to be achieved is to provide an improved concept for a bed frame which contributes to an easy and efficient mounting of the bed frame.

According to a first aspect, a fastening system for connecting two frame elements of a bed frame, in particular for an adjustable bed, is disclosed. The two frame elements, e.g. a transverse frame element and a longitudinal frame element, each comprise a hollow profile. The fastening system comprises a mounting element, which is firmly attachable to an end of the first frame element, and a connector part, which is insertable into the hollow profile at an end of the second frame element and firmly connectable to the second frame element. The mounting element comprises at least one mounting hole. The connector part comprises at least one mounting spigot corresponding to the at least one mounting hole, which is designed to be plugged into the at least one mounting hole. The connector part comprises at least one mounting mechanism for a detachable, firm connection of the mounting element and the connector part.

A bed frame, in particular a bed frame for an adjustable bed, comprises at least two longitudinal frame elements and at least one transverse frame element, wherein the transverse frame element connects the two longitudinal frame elements at respective ends. Optionally, a bed frame can comprise a second transverse frame element, which connects the two longitudinal frame elements at an opposite side, in particular at respective ends. Typically, the longitudinal frame elements comprise electronic and/or mechanical adjustment means, e.g. an adjustment mechanism, in order to adjust the bed, in particular the above-mentioned head, center and/or foot parts. Therefore, the longitudinal elements are also called kinematic frame elements. E.g., the adjustment mechanism comprises at least one or more segments, in particular joint or lever arms, which support the head part, the centre part and/or the foot part. In general, the frame elements are support elements for supporting a person and components like a mattress. The frame elements can also be called support frame elements.

The described fastening mechanism is designed to allow an easy and efficient connection of two such frame elements, in particular a longitudinal frame element and a transverse frame element of a bed frame. For the connection of the two frame elements in a proper use, the mounting element is attached to an end of the first frame element, wherein the connector part is inserted into the hollow profile at an end of the second frame element and attached thereto. For connecting the two frame elements the connector part needs to be plugged into the mounting element, wherein a mounting spigot (also named pin) is plugged into a corresponding mounting hole of the mounting element. Thus, a form-fit connection and a pre-positioning is achieved. Further, the connector part comprises at least one mounting mechanism in order to firmly, but detachably connect the mounting element and the connector part. In other words, a fastening mechanism provides an easy mounting mechanism, wherein the frame elements can be easily connected in a form-fitting manner and subsequently fastened by the mounting mechanism.

The fastening system takes into account different bed sizes. The fastening system allows a flexible configuration and assembly of a bed frame from several individual frame parts. The fastening system contributes to a modular bed frame, which contributes to a reduced effort in logistics and storage, for example. The simple structure of the fastening system also allows to reduce the weight of the frame and/or the bed. This is particularly relevant for distribution of a bed by mail order (especially online direct shipping), in which items are selected (configured) by the buyer according to his wishes. The fastening system contributes to a cheap and easy transport, in particular it allows small packaging dimensions and low weights. This reduces transport costs since a preassembled, space-consuming frame does not need to be transported. The bed can be transported to the installation side in modules, which provides advantages in view of transport of the frame elements in closed environments or buildings such as staircases and doors. Also, disassembly of the bed and rebuilding it in another location is possible, wherein the fastening system particularly contributes to a high stability even after repeated disassembly and assembly. Further, a stable and non-creaking assembly of the frame element is possible. Further, since changes of residence are quite common as indicated above, the disclosed fastening system contributes to the advantage that a bed can be easily mounted and dismounted, wherein the fastening system provides a stable assembly even after multiple mounting and demounting processes.

As an example, the fastening system and the frame elements connected thereto may have one or more of the following characteristics, e.g. in order to meet the requirements for a mail order:
They have no protruding parts (such as protruding parts at right angles) where the buyer may get stuck, or make the packaging more complicated.
There are no sharp edges where the buyer could be injured.
There are no areas where a person could squeeze his or her fingers.
Screws and other hardware are captive.

The connector part is at least partially inserted into the hollow profile of the second frame element. The connector part elongates the frame element in a main extending direction of the second frame element. The connector part is exemplarily made of plastics.

The mounting mechanism comprises, for example, a screw mechanism. As an alternative, the mounting mechanism of the connector part is provided as a latching or quick mounting mechanism, for example a snap-fit or snap-in mechanism. In embodiments, only one mounting mechanism is provided at the connector part. Only one mounting mechanism means that the mounting mechanism comprises only one connection means for firmly connecting the mounting element and the connector part. E.g. only one screw is provided for a screw connection. As another example, only one connection means for a snap-fit connection is provided.

The mounting element is for example a mounting plate, or a L-shaped or U-shaped element, wherein the L-shaped or U-shaped element comprise a mounting plate with one or more legs extending thereof. For example, one leg may serve as support element for supporting the second frame element prior to the final mounting of the second frame element to the first frame element via the fastening system. In other words, the one or more legs serve as installations aids.

The at least one spigot and mounting mechanism are arranged so that a frame element cannot be mounted incorrectly (Poka Yoke principle). Incorrect means that the lower edge of the frame element member is mounted upwards.

According to one embodiment, the fastening system comprises a cover element, which—in an connected state of the first and the second frame element via the fastening system (i.e. when the first and second frame element are connected by the fastening system)—is detachably attachable to the first frame element and/or the second frame element and covers the mounting element and the connector part. The cover element contributes to an appealing design, wherein in particular the mounting mechanism is hidden by the cover element. For example, one should not be able to see a bed screwed together. The cover element is made from plastics, for example.

According to one embodiment the cover element comprises a latching mechanism in order to be releasably attached to the first and/or the second frame element. This allows for an easy attachment of the cover element, wherein in particular no further elements such as a screw are necessary.

According to one embodiment the cover element is designed such that in the connected state of the first and second frame element the outer areas of the cover element are flush with corresponding outer areas of the first and second frame element. This allows for a compact and simple design, wherein the mounting components like the mounting mechanism and the at least one spigot are hidden.

According to one embodiment the mounting mechanism is captive connected to the connector part, at least in an attached state in which the connector part is attached to the second frame element. This means that, at least under normal conditions and during proper use, the mounting mechanism is secured at the connector part and the associated second frame element. Thus, the mounting mechanism cannot fall from or be released from the connector part and the second frame element, for example during transport or the mounting of the bed frame. Of course, the mounting mechanism is arranged such as to be accessible from the outside in order to mount the second frame element onto the first frame element.

According to one embodiment, the mounting element comprises a thread and the mounting mechanism of the connector part comprises a screw in order to be screwed into the thread of the mounting element for a screw connection of the connector part and the mounting element. This mounting mechanism allows for an easy and compact design, which is additionally cost-efficient. Further, an easy mounting is possible at a customer site. For example the connector part comprises a corresponding receiving element for the screw, e.g. a bore hole or a thread in the connector part. For example, the screw is pre-inserted into the bore hole before the connector is inserted into the second frame element. For example, into the thread, the screw is pre-screwed before the connector is inserted and fixed to the second frame element.

According to one embodiment, the connector part comprises at least one abutment element in order to limit an insertion of the connector part into the hollow profile of the second frame element. This allows to correctly position the connector part at the second frame element. Further, the mounting mechanism, e.g. a screw, is captive connected on the connector part in the inserted state as indicated above. For example, a part of the screw is covered by the hollow profile of the second frame element such that the screw cannot fall from the second frame element and the connector element in the inserted state but is still accessible to be screwed into the corresponding mounting element.

According to one embodiment, the connector part has at least two mounting spigots and the mounting element has at least two corresponding mounting holes. Thus, a mechanical stability of the two frame elements in the attached state is improved.

According to one embodiment the at least two mounting spigots comprise a different length. This allows for an improved pre-positioning of the connector part at the mounting element. The longer spigot, which can also be called guiding spigot or guiding pin, allows for a pre-positioning of the second frame element to the first frame element, in that the guiding spigot is plugged first into the corresponding mounting hole. Subsequently, the second spigot can be much more easily plugged into the corresponding mounting hole.

According to one embodiment each mounting spigot comprises a length which is smaller than 2 cm. In particular, the length of the spigot is chosen such that the second frame element is supported on the first frame element by the spigots even before the connector part is firmly attached to the mounting element via the mounting mechanism. For example, the second frame element is held on the first frame element via the at least one spigot prior to screwing the connector part to the mounting element.

It is noted that the connector part and the mounting element each comprise a mounting area, which contacts in the connected and mounted state. The length of the spigots is defined by the outermost end of the spigot and the respective mounting side of the connector part, from which the spigots extend.

According to one embodiment, the mounting mechanism of the connector part does not extend beyond a mounting spigot of the connector part in a state in which the connector part is not connected to the mounting element. This allows for an easy placement of the spigot in the corresponding mounting hole.

According to one embodiment the mounting element does not extend beyond the hollow profile of the first frame element in the attached state in which the mounting element is attached to the first frame element. This allows for easy transportation, wherein in particular no parts of the mounting element extend beyond the hollow profile.

According to one embodiment the connector part does not extend beyond the hollow profile of the second frame in an inserted state in which the connector part is inserted into the second frame element, apart from the at least one mounting spigot and the mounting mechanism. In other words, outer areas or surfaces of the connector part are essentially flush or aligned with the second frame element. Similarly, this allows for a simple and easy transport.

According to a second aspect, a bed frame, in particular for an adjustable bed, is disclosed. The bed frame comprises at least a first frame element and a second frame element, wherein the two frame elements each comprise a hollow profile. Further, the bed frame comprises a fastening system according to any one of the preceding embodiments. The mounting element of the fastening system is firmly attached to an end of the first frame element. The connector part of the fastening system is partially inserted into the hollow profile at an end of the second frame element and is firmly attached to the second frame element. The at least one mounting spigot of the connector part is plugged into a corresponding at least one mounting hole of the mounting element. The connector part and the mounting element are detachably and firmly connected via the at least one mounting mechanism of the connector part.

The bed frame essentially contributes to the above-mentioned functions and advantages.

According to one embodiment, the mounting element is screwed or welded to the first frame element. Thus, an undetachable attachment is achieved.

According to one embodiment the connector part is attached to the second frame element by pressing, glueing or screwing. Thus, an undetachable attachment is achieved. This allows for an easy and cost-efficient production.

According to one embodiment the mounting mechanism is a screw, which screw is inserted into the connector part, wherein the screw is at least partially covered by the hollow profile of the second frame element such that—in an attached state in which the connector part is attached to the second frame element—the screw is captive connected. Thus, the screw is captive connected between the hollow profile of the second frame element and the connector part, but still accessible in order to screw the connector part to the mounting element.

The above-mentioned features, functions and advantages with regard to the fastening system apply to the bed frame in an analogous way.

Further features and advantages are explained in greater detail by the exemplary embodiment with reference to the attached figures. In the figures, like or similar components are denoted with the same reference numerals. Features that have already been described using reference numerals are not necessarily provided with reference numerals throughout all the figures.

The figures show in:

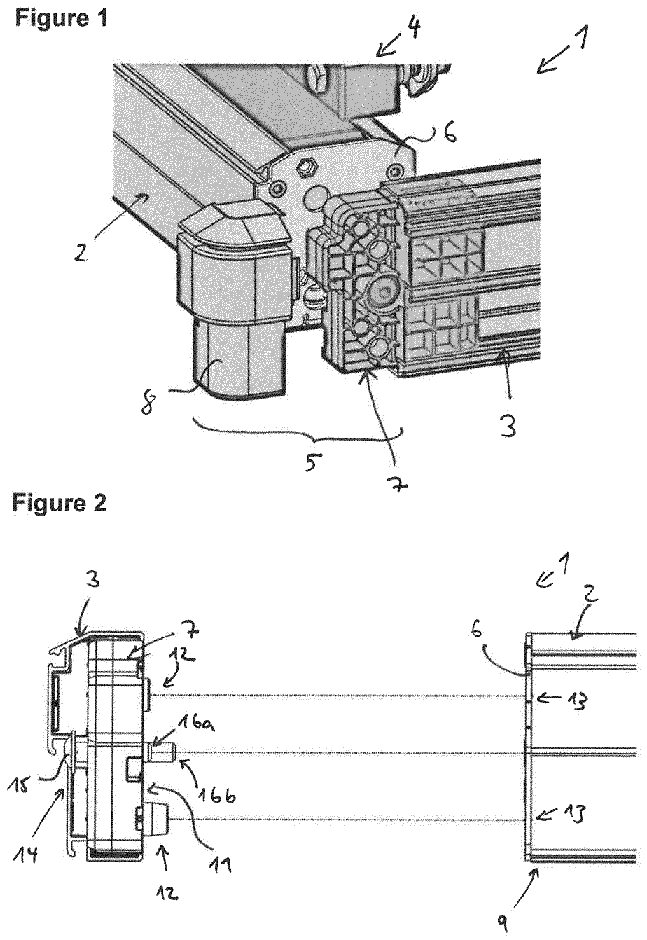

FIG. 1 a schematical, perspective view of the fastening system and two frame elements of a bed frame;

FIG. 2 a schematical side view of the bed frame according to FIG. 1;

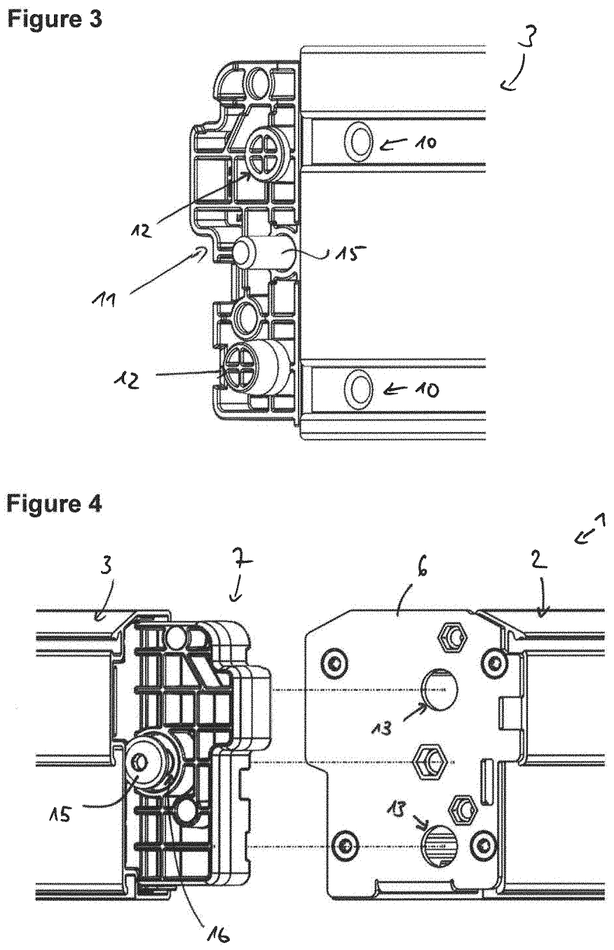

FIG. 3 a schematical, perspective view of a frame element comprising the connector part of the fastening system;

FIG. 4 a schematical, perspective view of the bed frame comprising the fastening system;

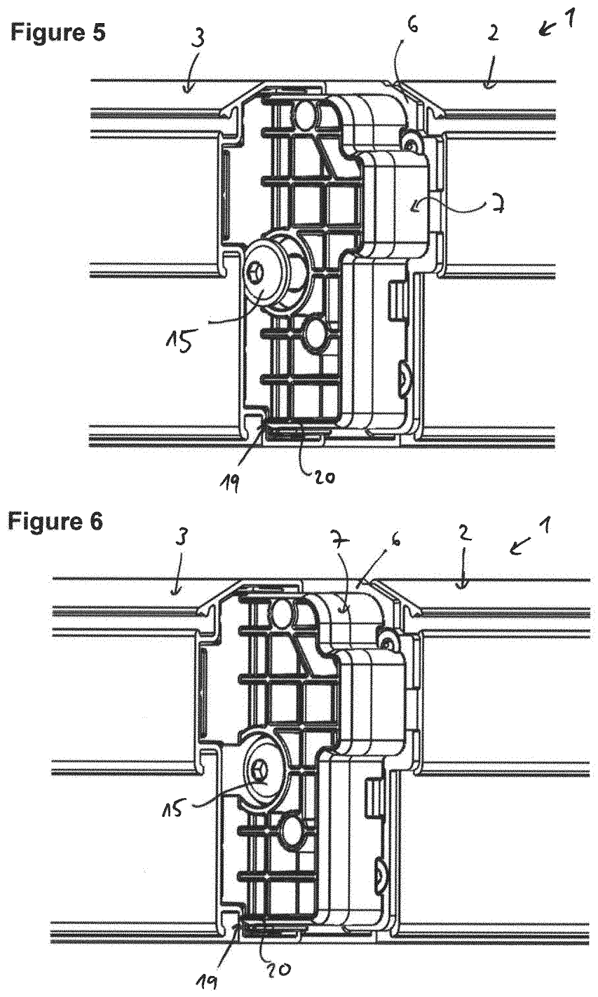

FIG. 5 a schematical, perspective view of the bed frame in a plugged but unconnected state;

FIG. 6 a schematical, perspective view of the bed frame in a plugged and connected state;

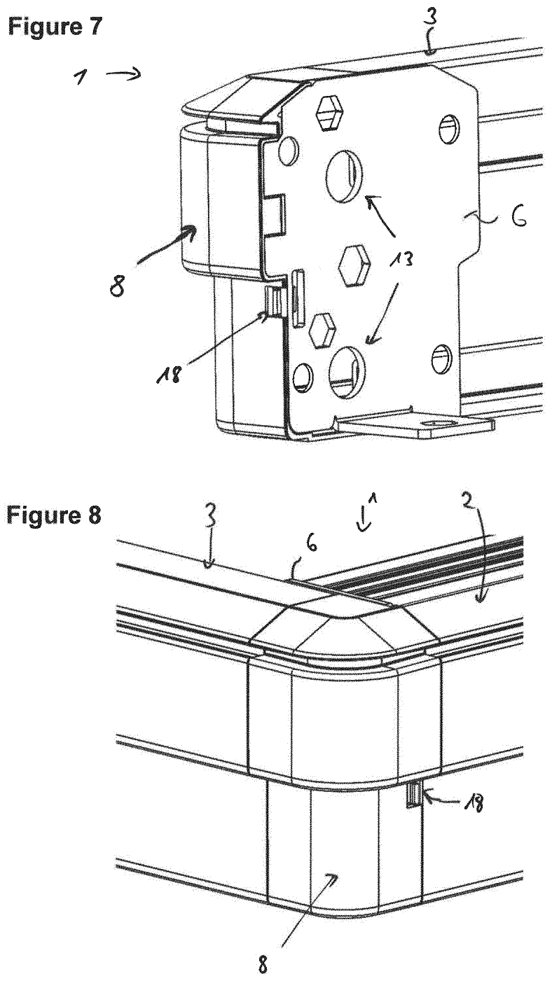

FIG. 7 a schematical, perspective view of the bed frame with the fastening system; and

FIG. 8 the bed frame with the fastening system and a cover element in a fully mounted state.

FIG. 1 shows a perspective partial view of a bed frame 1 for an adjustable bed. The bed frame 1 comprises two longitudinal frame elements 2 and at least one transverse frame element 3 which are also referred to as a first and a second frame element of the bed frame 1. In FIG. 1 only parts of one longitudinal frame element 2 and one transverse element 3 are shown. The least one longitudinal frame element 2 comprises an adjustment mechanism 4 for adjusting the adjustable bed (partially indicated). Both the longitudinal frame element 2 and the transverse frame element 3 comprise a hollow profile and are made from metal. The profiles can be polygonal or comprise any other form.

In order to connect the longitudinal frame element 2 and the transverse frame element 3 a fastening system 5 is provided, which comprises a mounting plate 6 (mounting element) and a connector part 7 as well as a cover element 8. The fastening system 5 and the cover element 8 are described in more detail with respect to FIGS. 2 to 8. It is noted that in the following only one fastening system 5 connects a transverse frame element 3 with a longitudinal frame element 2. Of course, the same transverse frame element 3 may be connected to another longitudinal frame element via an additional fastening system 5.

The mounting plate 6 is firmly attached to an end 9 of the longitudinal frame element. For example, the mounting plate 6 is welded or screwed firmly to the longitudinal frame element 2. The mounting plate 6 is made from metal and does not extend beyond the hollow profile of the longitudinal frame element 2 in the attached state as shown in FIG. 1 or 2, for example. Moreover, an edge of the mounting plate 6 is slightly offset towards the inside in order that the cover element 8, which is described later, can be attached in order to be flush with the outer area or surfaces of the longitudinal frame element 2.

The connector part 7 is an insert part and is exemplarily made from plastics. The connector part 7 is at least partially inserted into the hollow profile of the transverse frame element 3. In order to limit an insertion of the connector part 7, the connector part 7 comprises at least one abutment element which limits the insertion. After the insertion of the connector part, the connector part, which is also shown perspectively in FIG. 3, is firmly attached to the transverse frame element by pressing the transverse frame element 3 from outside. As an example, FIG. 3 shows two pressing points 10.

The connector part 7 is designed for frame elements of different length. E.g. during production, the strand material for the frame element is cut in the desired length (e.g. bed width) and two connector parts 7 are plugged into ends of the transverse frame element. At the same time the openings, which may have cutting burrs, are closed, which minimizes risk of injury. Likewise, the longitudinal frame element 2 is closed by the mounting plate 6.

A mounting side 11 of the connector part 7 which is configured for facing the mounting plate 6 comprises at least two mounting spigots 12. The mounting plate 6 comprises two corresponding mounting holes 13, which are adapted for receiving the mounting spigots 12. The number of spigots 12 (pins) and holes 13 in the mounting plate 6 does not necessarily have to be the same size. The pins are typically cylindrical, possibly with a rounded tip, and the holes allow the snug fit of the pins. In principle, however, the pins could also have other angular shapes. The holes 13 are drilled or punched. When using multiple pins, the connection is more stable.

The mounting spigots 12 have different lengths but do not extend beyond 2 cm from the mounting side 11. The longer spigot 12 can also be called guiding spigot and simplifies insertion of the spigots 12 when using a plurality of spigots. This longer spigot 12 serves as a guide pin and after insertion of the longer spigot 12 a minimal alignment of the remaining spigots 12 is possible and the remaining spigots are easier to insert.

As can be seen from FIGS. 2 and 4, the connector part 7 additionally comprises a mounting mechanism 14 in the form of a screw 15. FIG. 2 shows two end positions 16a and 16b of the screw, wherein the first end position 16a corresponds to an unconnected state of the connector part 7 and the mounting plate and wherein the end position 16b shows the fully screwed position of the screw 15, if the connector part 7 is fully mounted on the mounting plate 6, as is described below.

As can be further seen from FIG. 4, in the inserted state of the connector part 7, the screw 15 is at least partially covered by the hollow profile of the transverse frame element 3. During production, the screw 15 is firstly inserted into a corresponding bore hole 16 of the connector part 7. The screw 15 is slightly moveable within the bore hole 16 of the connector part 7. Secondly, the connector part 7 is inserted into the hollow profile of the transverse frame element 3 until the connector part 7, in particular its abutment element 19, abuts against the hollow profile. In this state, the screw 15, in particular a screw head, is at least partially covered by the hollow profile of the transverse frame element 3 such that the screw 15 is secured between the hollow profile and the connector part 7 but is still accessible in order to be screwed afterwards with the mounting plate 6.

As can be seen from at least FIG. 2, the connector part 7, as well as the mounting plate 6 of the longitudinal frame element 2, do not extend beyond the hollow profile of the transverse frame element 3, besides the spigots 12 and the screw 15 which extend from the connector part 7 at the mounting side 11.

In following the connection of both frame elements 2 and 3 is described with respect to FIGS. 5 and 6.

The connector part 7, attached to the transverse frame element 3, is plugged into the mounting plate 6 of the longitudinal frame element 2. Firstly, the longer spigot 12 is plugged into the corresponding hole 13 and secondly the shorter spigot 12 is placed into its corresponding mounting hole 13 (see also FIG. 2). The holes 13 are arranged so that the transverse frame element 3 cannot be mounted upside down (Poka Yoke). The spigots 12 are provided with sufficient length so that the transverse frame element 3 is already held by the spigots after plugging into the longitudinal frame element 2 until the screw 15 is tightened. After plugging the transverse frame element 3 to the longitudinal frame element 2, the screw 15 is tightened with a simple tool and a stable connection between the frame elements 2 and 3 is established.

In FIGS. 5 and 6 at least one abutment element 19 of the connector part 7 is shown. In the exemplary embodiment, a bottom horizontal bar 20 of the connector part 7 projects beyond the lower end of the hollow profile of the transverse frame element 3 and thus forms a stop.

After the connection a cover element 8 is attached on the respective corner in order to hide the fastening system 5 (see FIGS. 7 and 8). In FIG. 7, the longitudinal frame element 2 is hidden for the sake of visibility of the mounting plate 6 from inside.

The cover element 8 is typically made of plastic and serves the purpose of visual enhancement as well as protection of a user from unwanted access to the fastening systems 5. The cover element 8 covers, on the one hand, the mounting plate 6 and, on the other hand, the connector part 7 with the screw 15. The cover element 8 is flush with both frame elements 2 and 3, in particular the outer areas of the cover element 8 are arranged flush. The cover element 8 is attached with the help of a latching mechanism 18.

1. Fastening system for connecting two frame elements of a bed frame, in particular for an adjustable bed, wherein the two frame elements each comprise a hollow profile, the fastening system comprising:
a mounting element, which is firmly attachable to an end of the first frame element, and
a connector part, which is insertable into the hollow profile at an end of the second frame element and firmly connectable to second frame element,
wherein
the mounting element comprises at least one mounting hole,
the connector part comprises at least one mounting spigot corresponding to the at least one mounting hole, which is designed to be plugged into the at least one mounting hole,
the connector part comprises at least one mounting mechanism for a detachable, firm connection of the mounting element and the connector part.

2. The fastening system of claim 1, comprising a cover element, which—in an connected state of the first and the second frame element via the fastening system—is detachably attachable to the first frame element and/or the second frame element and covers the mounting element and the connector part.

3. The fastening system of claim 2, wherein the cover element comprises a latching mechanism in order to be releasably attached to the first and/or second frame element.

4. The fastening system of claim 2 or 3, wherein the cover element is designed such that, in the connected state of the first and second frame element, the outer areas of the cover element are flush with corresponding outer areas of the first and second frame element.

5. The fastening system of claim 1, wherein the mounting mechanism is captive connected to the connector part, at least in an attached state in which the connector part is attached to the second frame element.

6. The fastening system of claim 1, wherein the mounting element comprises a thread and the mounting mechanism of the connector part comprises a screw in order to be screwed into the thread of the mounting element for a screw connection of the connector part and the mounting element.

7. The fastening system of claim 1, wherein the connector part comprises at least one abutment element in order to limit an insertion of the connector part into the hollow profile of the second frame element.

8. The fastening system of claim 1, wherein the connector part has at least two mounting spigots and the mounting element has at least two corresponding mounting holes.

9. The fastening system of claim 8, wherein the at least two mounting spigots comprise a different length.

10. The fastening system of claim 8 or 9, wherein the at least two mounting spigots each comprise a length which is smaller than 2 cm.

11. The fastening system of claim 1, wherein the mounting mechanism of the connector part does not extend beyond a mounting spigot of the connector part in a state in which the connector part is not connected to the mounting element.

12. The fastening system of claim 1, wherein the mounting element does not extend beyond the hollow profile of the first frame element in the attached state in which the mounting element is attached to the first frame element.

13. The fastening system of claim 1, wherein the connector part does not extend beyond the hollow profile of the second frame element in the inserted state in which the connector part is inserted into the second frame element, apart from the at least one mounting spigot and the mounting mechanism.

14. Bed frame, in particular for an adjustable bed, comprising:
at least a first frame element and a second frame element, wherein the two frame elements each comprise a hollow profile,
a fastening system according to any one of the preceding claims,
wherein
the mounting element is firmly attached to an end of the first frame element,
the connector part is partially inserted into the hollow profile at an end of the second frame element and firmly attached to the second frame element,
the at least one mounting spigot of the connector part is plugged into a corresponding at least one mounting hole of the mounting element, and
the connector part and the mounting element are detachably and firmly connected via the least one mounting mechanism of the connector part.

15. The bed frame of claim 14, wherein the mounting element is screwed or welded to the first frame element.

16. The bed frame of claim 14, wherein the connector part is attached to the second frame element by pressing, glueing or screwing.

17. The bed frame of claim 14, wherein the fastening system comprises a cover element, which is detachably attached to the first frame element and/or the second frame element by a latching mechanism and covers the mounting element and the connector part.

18. The bed frame of claim 14, wherein the mounting mechanism is a screw, which screw is inserted into the connector part, wherein the screw is at least partially covered by the hollow profile of the second frame element such that—in an attached state in which the connector part is attached to the second frame element—the screw is captive arranged.
